(19) United States
(12) Patent Application Publication
(10) Pub. No.: US 2023/0137195 A1
(43) Pub. Date: May 4, 2023

(54) A COMPRESSED AIR SYSTEM

(71) Applicant: MIKROPOR MAKINA SANAYI VE TICARET A.S., Sincan/ Ankara (TR)

(72) Inventor: Ibrahiml Kemal YAZICI, Ankara (TR)

(21) Appl. No.: 17/912,399

(22) PCT Filed: Apr. 6, 2020
(86) PCT No.: PCT/TR2020/050273

§ 371 Date: Sep. 16, 2022

(30) Foreign Application Priority Data
Mar. 16, 2020 (TR) 2020/03987

(51) Int. Cl. F04B 39/16; B01D 39/20; B01D 46/00

(52) U.S. Cl. CPC F04B 39/16; B01D 39/2062; B01D 46/0031; B01D 46/0002; B01D 2101/02

(57) ABSTRACT

Disclosed herein is a system that performs the separation of incoming liquid and vapor oil by a single system. The disclosure is a compressed air system for separating liquid- and vapor-form oil from the air, including a filter element that comprises an air-oil separator that separates liquid-form oil from the air, an activated carbon filter positioned after the air-oil separator, separating the vapor oil from the air; and a housing, in which the said filter element is placed, having at least two discharge elements for discharging liquid-form oil, an inlet port for the inlet of air and an outlet port for the outlet of the air.

### FIELD OF THE DISCLOSURE

The disclosure relates to a compressed air system that enables the separation of incoming liquid and vapour form oil by a single system.

### BACKGROUND

According to the process applied in compressed air systems used in the current art, the air must be conditioned and separated from oil, water and moisture. In compressed air systems developed according to the ISO 8573.1:2010 standard “0” class conditions, the incoming oil concentration in both vapour and liquid form should be no more than 0.03 mg/m³.

It is known that two different compressed air filters are used in compressed air systems used in the art, which are active carbon filters and air-oil separator filters for separating the oil in liquid form and in vapour form. The use of these two different filters complicates the system and makes the separation process difficult. To ensure that a more efficient separation process is performed, a more compact system needs to be developed.

The utility model document no. CN209212502U may be referred as an example of the state of the art. The said document features a compressed air-oil extraction device. It is reported that one end of the said device is permanently connected to an air compressor and the other end is connected to an air dryer and an air storage tank, respectively. It is further described that a catalytic reaction tank, a heat exchanger and an electrical control unit are permanently placed at the base; a heater is placed outside the catalytic reaction tank, the top and bottom of the catalytic reaction tank are connected through the pipelines with a fixed heat exchanger, an air outlet pipe and an air inlet pipe are arranged on the heat exchanger, and the electric control unit is electrically connected to the catalytic reaction tank, the heat exchanger and the heater respectively. It is reported that the system mentioned in the said document can produce the oil-free compressed air, meeting the ISO 8573.1 grade. However, there is no mention of a system for the development of a more compact system to eliminate the above-mentioned disadvantages.

In order to eliminate the technical disadvantages, the need still remains for the development of a more compact system, which minimizes energy losses, and at the same time ensures an air quality meeting the mentioned standards.

### SUMMARY

The disclosure relates to a compressed air system that enables the separation of incoming liquid- and vapour-form oil by a single system.

The present disclosure is related to separation of liquid and vapour oil in compliance with the ISO8573.1 2010 standard by a single system according to the class “0” requirements.

The object of the disclosure is to minimize energy losses. For this purpose, a filter element has been developed that contains the air-oil separator (7) and the activated carbon filter (9) together.

The system according to the disclosure comprises, generally, a filter element comprising an air-oil separator (7) that provides the separation of the liquid oil and an activated carbon filter (9) that is located after the air-oil separator (7), providing the separation the vapour form oil from the air; a housing (12) in which the filter element is installed/mounted, having at least two discharge elements (13) for discharging liquid oil, an inlet port (14) for inlet air and an outlet port (15) for outlet air.

In an embodiment of the disclosure, the activated carbon filter (9) contains activated carbon granules or activated carbon filter media.

An embodiment of the disclosure includes a body sheet (6), protection sheet (8), inner sheet (10) and outer sheet (3) to provide strength and to protect the filter media.

An embodiment of the disclosure includes a particle filter media (11) in which solid particles are captured. After separation process, the said filter media is also used to capture solid particles that may be formed due to activated carbons in the air passing through the activated carbon filter (9). Therefore, in one embodiment of the disclosure, the particle filter media (11) is positioned after the activated carbon filter (9).

In the system of the disclosure, the housing (12) comprises more than one discharge element (13), an inlet port (14) where oily air enters the system, and an outlet port (15) for discharging the oil separated air.

In an embodiment of the disclosure, there are at least two discharge elements (13) on the housing (12) to discharge the separated liquid-form oil from the system.

One embodiment of the disclosure includes two discharge elements (13), one of which is used to discharge the large amount of oil contained in the initial air, and the other is used to discharge the oil separated by the air-oil separator (7).

In an embodiment of the disclosure, there are more than one carrier legs to support the system.

In an embodiment of the disclosure, there are three carrier legs.

In an embodiment of the disclosure, the housing (12) comprises a housing cover (16).

The filter element of the disclosure is operated by placing it in a housing (12). The operating principle of the disclosure is as follows. Oily air first passes through the inlet port (14) of the housing (12) and enters the inner part of the filter element and passes through the air-oil separator (7). In this way, the oil in liquid form is separated from the air. The said separated oil is removed from the housing (12) by the discharge element (13) located in the housing (12). After the liquid oil is separated from the air, the vapour oil in the air is separated by the activated carbon filter (9). At the last stage, any solid particles to be formed due to activated carbon are captured by the particle filter media (11) and the air separated from the oil is discharged from the outlet port (15) and fed to the system.

One embodiment of the disclosure comprises the air-oil separator (7), activated carbon filter (9) and particle filter media (11), respectively from the inside of the filter element to the outside. In this case, the oil-containing air passes first through the air-oil separator (7), then through the activated carbon filter (9) and finally through the particle filter media (11).

In a figure regarding an embodiment of the disclosure, a view of section A is provided. As can be seen in this figure, there are body sheet (6), air-oil separator (7), protection sheet (8), activated carbon filter (9), inner sheet (10), particle filter media (11) and outer sheet (3), respectively from the inside to the outside of the filter element.

The present disclosure is, in summary, a compressed air system for separating the liquid- and vapour-form oil from the air, wherein it comprises a filter element comprising; an air-oil separator (7) that provides the separation of the liquid-form oil, an activated carbon filter (9) that provides the separation of the vapour-form oil from the air, a particle filter media (11) for holding coarse particles in the air, positioned such that the air encounters it after passing through the activated carbon filter (9); and a housing (12) in which the said filter element is placed, having at least two discharge elements (13) for discharging liquid oil, an inlet port (14) for the inlet of air and an outlet port (15) for the outlet of the air.

### BRIEF DESCRIPTION OF THE DRAWINGS

FIG. 1 is a perspective view of a filter element, according to at least one embodiment of the disclosure.

FIG. 2 is a side view of a filter element, according to at least one embodiment of the disclosure.

FIG. 3 is a sectional view of a filter element, and a view of a detail (A) in said sectional view, according to at least one embodiment of the disclosure.

FIG. 4 is a view of housing in which a filter element is mounted, according to at least one embodiment of the disclosure.

### DETAILED DESCRIPTION

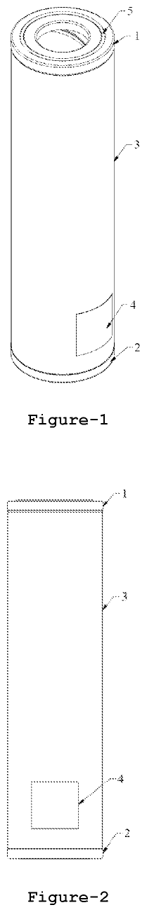

In FIG. 1 of the specification, there is a view of an embodiment of the disclosure. The said Figure features a cylindrical outer sheet (3), a lower cover (2) at the bottom of the outer sheet (3), an upper cover (1) at the top, an O-ring (5) to provide the connection at the upper cover (1) and an air baffle plate (4) on the outer sheet (3).

FIG. 2 of the specification also shows the filter element of an embodiment of the disclosure. It is seen that the said filter element includes an upper cover (1), a lower cover (2), an outer sheet (3), and an air baffle plate (4) located on the outer sheet (3).

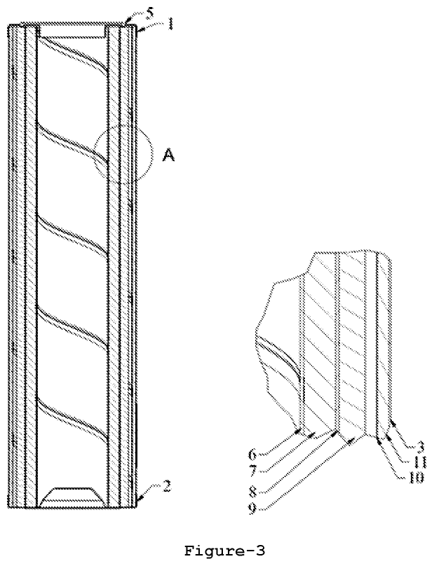

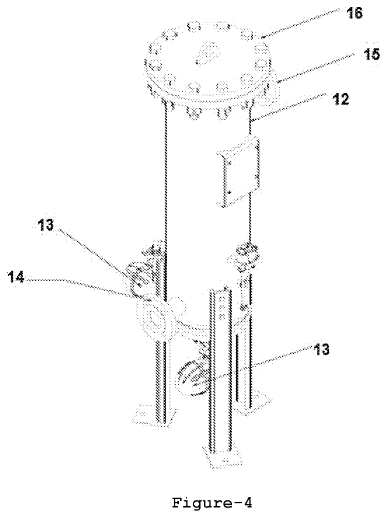

FIG. 3 of the specification is a sectional view of the filter element and a detail (A) of this sectional view. In the sectional view, the interior of the cylindrical filter element is shown, and the parts where the air travels are pointed by horizontal parallel lines. Also, in this figure, an upper cover (1), a lower cover (2), and an O-ring (5) located in the upper cover (1) are shown. In the sectional view related to detail “A”, the body sheet (6), air-oil separator (7), protection sheet (8), activated carbon filter (9), inner sheet (10), particle filter media (11) and outer sheet (3) are illustrated.

FIG. 4 of the specification shows the housing (12) in which the filter element of the disclosure is placed. This housing (12) comprises an inlet port (14), an outlet port (15), two discharge elements (13), one on the side surface of the housing (12) and the other in the lower part of the housing (12), and a housing cover (16). It is also illustrated that it includes three carrier legs to support the housing (12).

The present disclosure performs the separation of liquid and vapour oil from the air on a single filter element, thereby providing a more compact system and minimizing energy losses.

### REFERENCE NUMBERS

1. Upper cover
2. Lower cover
3. Outer sheet
4. Air baffle plate
5. O-ring
6. Body sheet
7. Air-oil separator
8. Protection sheet
9. Activated carbon filter
10. Inner sheet
11. Particle filter media
12. Housing
13. Discharge element
14. Inlet port
15. Outlet port
16. Housing cover

1. A compressed air system for separating the liquid- and vapor-form oil from the air, the system comprising:
a filter element that comprises:
an air-oil separator that separates liquid-form oil from the air,
an activated carbon filter positioned after the air-oil separator, separating the vapor oil from the air;
and
a housing, in which the said filter element is placed, having at least two discharge elements for discharging liquid-form oil, an inlet port for the inlet of air and an outlet port for the outlet of the air.

2. The system according to claim 1, wherein the activated carbon filter contains activated carbon granules or activated carbon filter media.

3. The system according to claim 1, wherein it comprises a particle filter media in which solid particles are captured.

4. The system according to claim 3, wherein the particle filter media is located after the activated carbon filter.

5. The system according to claim 1, wherein it comprises body sheet, protection sheet, inner sheet and outer sheet to provide strength and protect the filter media.

6. The system according to claim 5, wherein it comprises body sheet, air-oil separator, protection sheet, activated carbon filter, inner sheet, particle filter media and outer sheet, respectively from the inside to the outside of the filter element.

7. The system according to claim 1, wherein the filter element includes an upper cover and a lower cover.

8. The system according to claim 7, wherein it comprises an O-ring on the upper cover as a connecting element.

9. The system according to claim 5, wherein it comprises an air baffle plate on the outer sheet.

10. The system according to claim 1, wherein it comprises more than one carrier leg to support the housing.

11. The system according to claim 10, wherein it comprises three carrier legs.

12. The system according to claim 1, wherein the housing comprises a housing cover.

13. The system according to claim 1, wherein it comprises two discharge elements, one for discharging the high amount of oil contained in the air entering the system first, and the other for discharging the oil separated by the air-oil separator.
